(19) United States
(12) Patent Application Publication
(10) Pub. No.: US 2025/0148652 A1
(43) Pub. Date: May 8, 2025

(54) METHOD, APPARATUS, AND MEDIUM FOR POINT CLOUD CODING

(71) Applicants: Douyin Vision (Beijing) Co., Ltd., Beijing (CN); Bytedance Inc., Los Angeles, CA (US)

(72) Inventors: Wenyi WANG, Beijing (CN); Yingzhan XU, Beijing (CN); Kai ZHANG, Los Angeles, CA (US); Li ZHANG, Los Angeles, CA (US)

(21) Appl. No.: 19/015,338

(22) Filed: Jan. 9, 2025

Related U.S. Application Data
(63) Continuation of application No. PCT/CN2023/106410, filed on Jul. 7, 2023.

(30) Foreign Application Priority Data
Jul. 9, 2022 (WO) PCT/CN2022/104781
Oct. 10, 2022 (WO) PCT/CN2022/124421

(51) Int. Cl. G06T 9/00

(52) U.S. Cl. CPC G06T 9/001

(57) ABSTRACT

Embodiments of the present disclosure provide a solution for point cloud coding. A method for point cloud coding is proposed. The method comprises: determining, for a conversion between a current frame of a point cloud sequence and a bitstream of the point cloud sequence, first attribute information of a first node of the current frame based on second attribute information of a second node of the current frame, a node representing a spatial partition of the current frame, a first partition depth of the first node being different from a second partition depth of the second node; and performing the conversion based on the first attribute information.

### CROSS REFERENCE TO RELATED APPLICATIONS

This application is a continuation of International Application No. PCT/CN2023/106410, filed on Jul. 7, 2023, which claims the benefits of International Application No. PCT/CN2022/104781 filed on Jul. 9, 2022, and International Application No. PCT/CN2022/124421 filed on Oct. 10, 2022. The entire contents of these applications are hereby incorporated by reference in their entireties.

### FIELD

Embodiments of the present disclosure relates generally to point cloud coding techniques, and more particularly, to attribute information prediction.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a current frame of a point cloud sequence and a bitstream of the point cloud sequence, first attribute information of a first node of the current frame based on second attribute information of a second node of the current frame, a node representing a spatial partition of the current frame, a first partition depth of the first node being different from a second partition depth of the second node; and performing the conversion based on the first attribute information. The method in accordance with the first aspect of the present disclosure predicts attribute information of a second node based on attribute information of a first node with a different partition depth, and thus can improve the efficiency of the point cloud coding.

In a second aspect, another method for point cloud coding is proposed. The method comprises: determining, for a conversion between a current frame of a point cloud sequence and a bitstream of the point cloud sequence, at least one neighbour sub-node of a current node of the current frame, a node representing a spatial partition of the current frame; determining first attribute information of a sub-node of the current node based on at least one second attribute information of the at least one neighbour sub-node; and performing the conversion based on the first attribute information. The method in accordance with the second aspect of the present disclosure predicts attribute information of a sub-node of the current node based on attribute information of a neighbour node or a neighbour sub-node, and thus can improve the efficiency of the point cloud coding.

In a third aspect, another method for point cloud coding is proposed. The method comprises: determining, for a conversion between a current frame of a point cloud sequence and a bitstream of the point cloud sequence, at least one preceding sub-node coded before a current sub-node of a current node of the current frame, a node representing a spatial partition of the current frame; determining first attribute information of the current sub-node based on at least one second attribute information of the at least one preceding sub-node; and performing the conversion based on the attribute information. The method in accordance with the third aspect of the present disclosure predicts attribute information of a current sub-node based on attribute information of at least one previously coded preceding sub-node, and thus can improve the efficiency of the point cloud coding.

In a fourth aspect, another method for point cloud coding is proposed. The method comprises: determining, for a conversion between a current frame of a point cloud sequence and a bitstream of the point cloud sequence, based on an indicator, first attribute information of a sub-node of a current node of the current frame, a node representing a spatial partition of the current frame, wherein the indicator indicates whether the first attribute information is based on second attribute information of a first node of the current frame, a first partition depth of the first node being the same with a second partition depth of the sub-node of the current node; and performing the conversion based on the first attribute information. The method in accordance with the fourth aspect of the present disclosure uses an indicator to indicate whether to predict first attribute information of a sub-node based on second attribute information of another sub-node with the same partition depth, and thus can improve the efficiency of the point cloud coding.

In a fifth aspect, another method for point cloud coding is proposed. The method comprises: determining, for a conversion between a current frame of a point cloud sequence and a bitstream of the point cloud sequence, at least one of a neighbour node or a neighbour sub-node of current node, a node representing a spatial partition of the current frame, a sub-node is a portion of a node; applying a prediction operation to the current node based on at least one of a first prediction weight of the neighbour node or a second prediction weight of the neighbour sub-node; and performing the conversion based on the applying. The method in accordance with the fifth aspect of the present disclosure applies a prediction operation to the current node based on a prediction weight of a neighbour node or a prediction weight of a neighbour sub-node, and thus can improve the efficiency of the point cloud coding.

In a sixth aspect, an apparatus for processing point cloud sequence is proposed. The apparatus for processing point cloud sequence comprises a processor and a non-transitory memory with instructions thereon. The instructions upon execution by the processor, cause the processor to perform a method in accordance with the first, second, third, fourth, or fifth aspect of the present disclosure.

In a seventh aspect, a non-transitory computer-readable storage medium is proposed. The non-transitory computer-readable storage medium stores instructions that cause a processor to perform a method in accordance with the first, second, third, fourth, or fifth aspect of the present disclosure.

In an eighth aspect, a non-transitory computer-readable recording medium is proposed. The non-transitory computer-readable recording medium stores a bitstream of a point cloud sequence which is generated by a method performed by a point cloud processing apparatus. The method comprises: determining first attribute information of a first node of a current frame of the point cloud sequence based on second attribute information of a second node of the current frame, a node representing a spatial partition of the current frame, a first partition depth of the first node being different from a second partition depth of the second node; and generating the bitstream based on the first attribute information.

In a ninth aspect, a method for storing a bitstream of a point cloud sequence is proposed. The method comprises: determining first attribute information of a first node of a current frame of the point cloud sequence based on second attribute information of a second node of the current frame, a node representing a spatial partition of the current frame, a first partition depth of the first node being different from a second partition depth of the second node; generating the bitstream based on the first attribute information; and storing the bitstream in a non-transitory computer-readable recording medium.

In a tenth aspect, another non-transitory computer-readable recording medium is proposed. The non-transitory computer-readable recording medium stores a bitstream of a point cloud sequence which is generated by a method performed by a point cloud processing apparatus. The method comprises: determining at least one neighbour sub-node of a current node of a current frame of the point cloud sequence, a node representing a spatial partition of the current frame, a sub-node being a portion of a node; determining first attribute information of a sub-node of the current node based on at least one second attribute information of the at least one neighbour sub-node; and generating the bitstream based on the first attribute information.

In an eleventh aspect, a method for storing a bitstream of a point cloud sequence is proposed. The method comprises: determining at least one neighbour sub-node of a current node of a current frame of the point cloud sequence, a node representing a spatial partition of the current frame, a sub-node being a portion of a node; determining first attribute information of a sub-node of the current node based on at least one second attribute information of the at least one neighbour sub-node; generating the bitstream based on the first attribute information; and storing the bitstream in a non-transitory computer-readable recording medium.

In a twelfth aspect, another non-transitory computer-readable recording medium is proposed. The non-transitory computer-readable recording medium stores a bitstream of a point cloud sequence which is generated by a method performed by a point cloud processing apparatus. The method comprises: determining at least one preceding sub-node coded before a current sub-node of a current node of a current frame of the point cloud sequence, a node representing a spatial partition of the current frame, a sub-node being a portion of a node; determining first attribute information of the current sub-node based on at least one second attribute information of the at least one preceding sub-node; and generating the bitstream based on the first attribute information.

In a thirteenth aspect, a method for storing a bitstream of a point cloud sequence is proposed. The method comprises: determining at least one preceding sub-node coded before a current sub-node of a current node of a current frame of the point cloud sequence, a node representing a spatial partition of the current frame, a sub-node being a portion of a node; determining first attribute information of the current sub-node based on at least one second attribute information of the at least one preceding sub-node; and generating the bitstream based on the first attribute information.

In a fourteenth aspect, another non-transitory computer-readable recording medium is proposed. The non-transitory computer-readable recording medium stores a bitstream of a point cloud sequence which is generated by a method performed by a point cloud processing apparatus. The method comprises: determining, based on an indicator, first attribute information of a sub-node of a current node of a current frame of the point cloud sequence, a node representing a spatial partition of the current frame, a sub-node being a portion of a node, wherein the indicator indicates whether the first attribute information is based on second attribute information of a first node of the current frame, a first partition depth of the first node being the same with a second partition depth of the sub-node of the current node; and generating the bitstream based on the first attribute information.

In a fifteenth a sixtieth aspect, a method for storing a bitstream of a point cloud sequence is proposed. The method comprises: determining, based on an indicator, first attribute information of a sub-node of a current node of a current frame of the point cloud sequence, a node representing a spatial partition of the current frame, a sub-node being a portion of a node, wherein the indicator indicates whether the first attribute information is based on second attribute information of a first node of the current frame, a first partition depth of the first node being the same with a second partition depth of the sub-node of the current node; generating the bitstream based on the first attribute information; and storing the bitstream in a non-transitory computer-readable recording medium.

In a sixteenth aspect, another non-transitory computer-readable recording medium is proposed. The non-transitory computer-readable recording medium stores a bitstream of a point cloud sequence which is generated by a method performed by a point cloud processing apparatus. The method comprises: determining at least one of a neighbour node or a neighbour sub-node of a current node of a current frame of the point cloud sequence, a node representing a spatial partition of the current frame, a sub-node being a portion of a node; applying a prediction operation to the current node based on at least one of a first prediction weight of the neighbour node or a second prediction weight of the neighbour sub-node; and generating the bitstream based on the applying.

In a seventeenth aspect, a method for storing a bitstream of a point cloud sequence is proposed. The method comprises: determining at least one of a neighbour node or a neighbour sub-node of a current node of a current frame of the point cloud sequence, a node representing a spatial partition of the current frame, a sub-node being a portion of a node; applying a prediction operation to the current node based on at least one of a first prediction weight of the neighbour node or a second prediction weight of the neighbour sub-node; generating the bitstream based on the applying; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example point cloud coding system, in accordance with some embodiments of the present disclosure;

FIG. 2 illustrates a block diagram that illustrates an example of a GPCC encoder, in accordance with some embodiments of the present disclosure;

FIG. 3 illustrates a block diagram that illustrates an example of a GPCC decoder, in accordance with some embodiments of the present disclosure;

FIG. 4 illustrates parent-level nodes for each sub-node of transform unit node;

FIG. 5 illustrates an example of the improvement of point cloud attribute transform domain prediction;

FIG. 6 illustrates another example of the improvement of point cloud attribute transform domain prediction;

FIG. 7 illustrates a flowchart of a method for point cloud coding in accordance with some embodiments of the present disclosure;

FIG. 8 illustrates a flowchart of another method for point cloud coding in accordance with some embodiments of the present disclosure;

FIG. 9 illustrates a flowchart of another method for point cloud coding in accordance with some embodiments of the present disclosure;

FIG. 10 illustrates a flowchart of another method for point cloud coding in accordance with some embodiments of the present disclosure;

FIG. 11 illustrates a flowchart of another method for point cloud coding in accordance with some embodiments of the present disclosure; and

FIG. 12 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

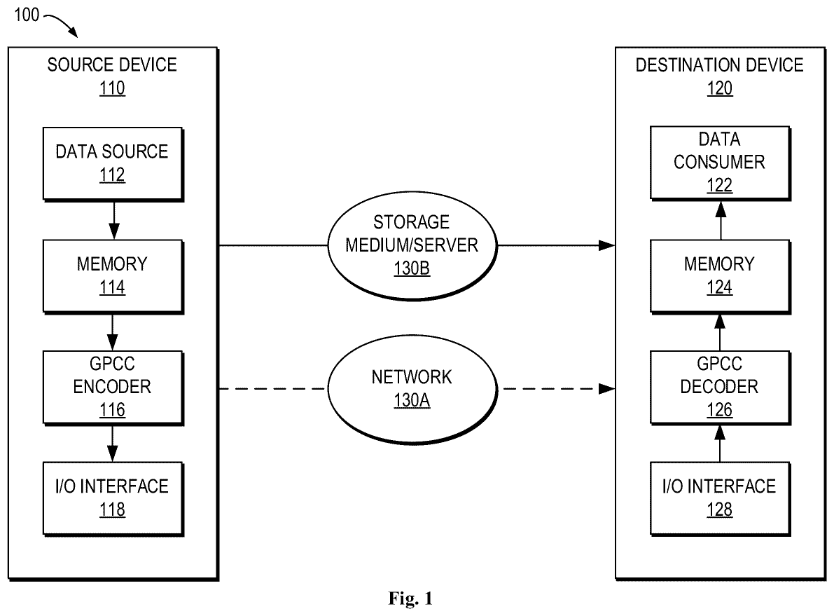

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

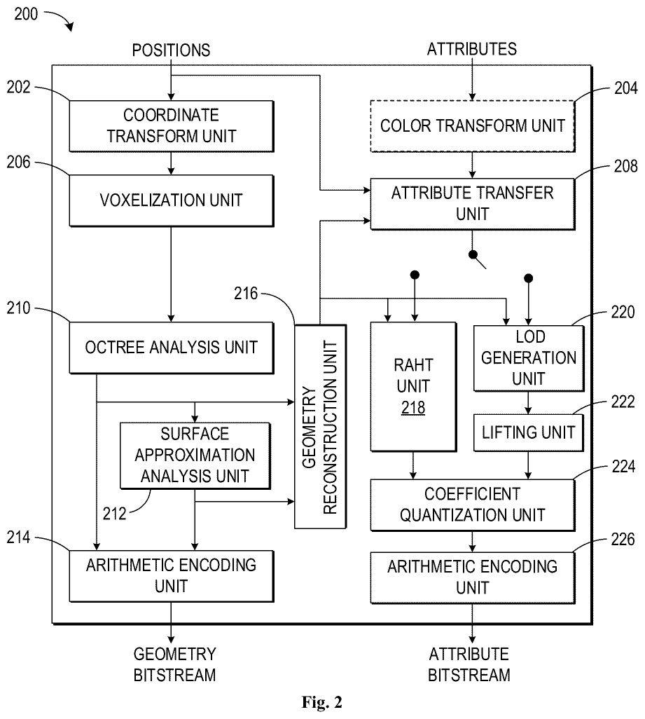

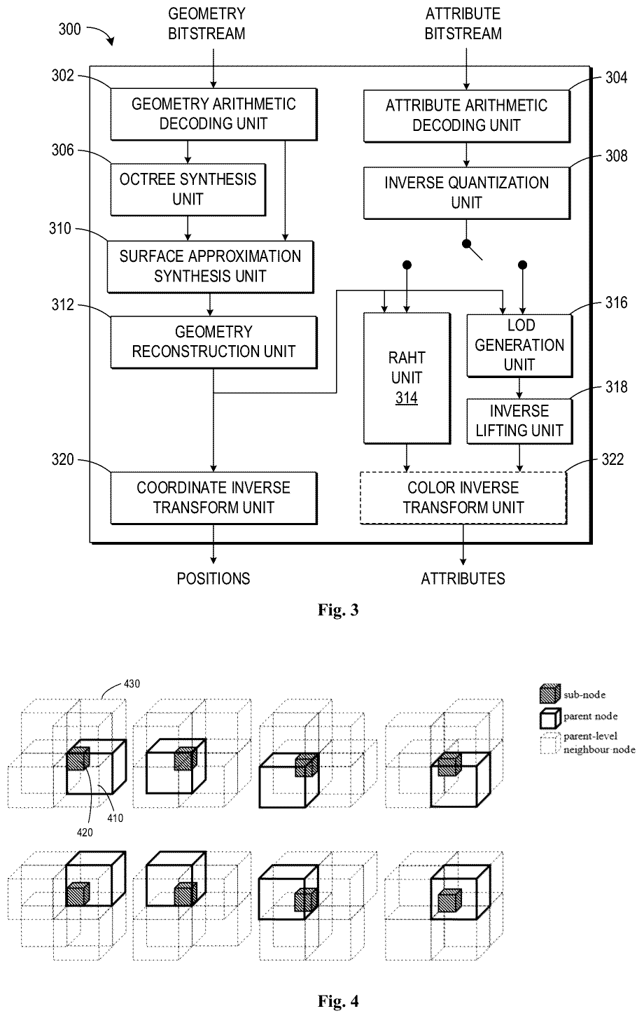

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively, or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. BRIEF SUMMARY

This disclosure is related to point cloud coding technologies. Specifically, it is related to point cloud attribute transform domain prediction in region-adaptive hierarchical transform. The ideas may be applied individually or in various combination, to any point cloud coding standard or non-standard point cloud codec, e.g., the being-developed Geometry based Point Cloud Compression (G-PCC).

### 2. ABBREVIATIONS

| | |
|---|---|
| G-PCC | Geometry based Point Cloud Compression |
| MPEG | Moving Picture Experts Group |
| 3DG | 3D Graphics Coding Group |
| CFP | Call For Proposal |
| V-PCC | Video-based Point Cloud Compression |
| RAHT | Region-Adaptive Hierarchical Transform |
| SPS | Sequence Parameter Set |
| APS | Attribute Parameter Set |
| GPS | Geometry Parameter Set |

### 3. INTRODUCTION

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Octree Geometry Compression

Point cloud codec can process the various information in different ways. Usually there are many optional tools in the codec to support the coding and decoding of geometry information and attribute information respectively. Among geometry coding tools in G-PCC, octree geometry compression has an important influence for point cloud geometry coding performance.

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is named occupancy bit and the 8-bit code generated is named occupancy code. The generated occupancy code will be signaled according to the occupancy information of neighbour node. Then only the nodes which contain points will be subdivided into 8 sub-nodes furtherly. The process will perform recursively until the node size is 1. So, the point cloud geometry information is converted into occupancy code sequences.

In decoder side, occupancy code sequences will be decoded and the point cloud geometry information can be reconstructed according to the occupancy code sequences.

A breadth-first scanning order will be used for the octree. In one level of the octree, the octree node will be scanned in a Morton order. If the coordinate of one node is represented by N bits, the coordinate (X, Y, Z) of the node can be represented as follows.

$$X = ( {x}_{N - 1} {x}_{N - 2} ⋯ {x}_{1} {x}_{0} )$$

$$Y = ( {y}_{N - 1} {y}_{N - 2} ⋯ {y}_{1} {y}_{0} )$$

$$Z = ( {z}_{N - 1} {z}_{N - 2} ⋯ {z}_{1} {z}_{0} )$$

Its Morton code can be represented as follows.

$$M = ( {x}_{N - 1} {y}_{N - 1} {z}_{N - 1} {x}_{N - 2} {y}_{N - 2} {z}_{N - 2} ⋯ {x}_{1} {y}_{1} {z}_{1} {x}_{0} {y}_{0} {z}_{0} )$$

The Morton order is the order from small to large according to Morton code.

### 3.2 Region-Adaptive Hierarchical Transform

In G-PCC, one of important point cloud attribute coding tools is RAHT. It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level 1 be g_{l,x,y,z}, for x, y, z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{1-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+1,y,z}, with their respective weights, ω_{l,2x,y,z} and ω_{l,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

Where ω₁=ω_{l,2x,y,z} and ω₂=ω_{l,2x+1,y,z} and

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z} .$$

In the last stage, the tree root, the remaining two voxels g_{1,0,0,0} and g_{1,1,0,0} are transformed into the final two coefficients as:

$$[ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ]$$

Where g_{DC}=g_{0,0,0,0}.

### 3.3 Up-Sampled Transform Domain Prediction in RAHT

The transform domain prediction is introduced to improve coding efficiency on RAHT. It is formed of two parts. Firstly, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Secondly, for each sub-node of transform unit, a corresponding predicted sub-node is produced by up-sampling the previous transform level. Actually, only sub-node that contains at last one point will produce a corresponding predicted sub-node. The transform unit that contains 2×2×2 predicted sub-nodes is transformed and subtracted from the transformed attributes at the encoder side. The residual of AC coefficients will be signalled. Note that the prediction does not affect the DC coefficient.

Each sub-node of transform unit node is predicted by 7 parent-level nodes where 3 co-line parent-level neighbour nodes, 3 co-plane parent-level neighbour nodes and 1 parent node. Co-plane and co-line neighbours are the neighbours that share a face and an edge with current transform unit node, respectively. FIG. 4 shows 7 parent-level nodes for each sub-node of transform unit node. For example, a node 410 (such as a current node) may be split or partitioned into a plurality of sub-nodes such as a sub-node 420. The node 410 may be referred to as a parent node of the sub-node 420. The node 410 may have a plurality of neighbour node (also referred to as parent-level neighbour node) such as a neighbour node 430. As used herein, a neighbour node may be a node sharing at least one of a face, an edge or a vertex with a certain node.

The attribute aᵤₚ of each sub-node is predicted depending on the distance between it and its parent-level node as follows.

$${a}_{up} = \sum {ω}_{k} {a}_{k} / \sum {ω}_{k}$$

aₖ is the attribute of its one parent-level node and ωₖ is weight depending on the distance. In G-PCC, ωₚₐᵣₑₙₜ:ω_{coplane}:ω_{coline}=4:2:1.

### 3.4 Coding Parameter Classification

There are some coding parameters in the encoder to control the encoding of point cloud. Some of them are signaled to the decoder to support the decoding process. The parameters can be classified and stored in several clusters according to the affected part of each parameter, such as geometry parameter set (GPS), attribute parameter set (APS) and sequence parameter set (SPS). The parameters that control the geometry coding tools are stored in GPS. The parameters that control the attribute coding tools are stored in APS. For example, the parameters that describe the attribute category of point cloud sequence and the data accuracy of coding process are stored in SPS.

### 4. PROBLEMS

The existing designs for point cloud attribute transform domain prediction in region-adaptive hierarchical transform have the following problems:
1. The attributes of parent-level neighbour nodes that share a face and an edge with current node is used to generate attribute of each sub-node of transform unit. However, among the parent-level neighbour nodes, some of them are encoded/decoded before current transform unit node. Consequently, the attribute of their sub-nodes is known when encoding/decoding the attribute of transform unit node. If the attribute of already-coded neighbours' sub-nodes can be used to predict the attribute of sub-nodes of transform unit, the attribute coding performance can be improved.
2. The weight of each parent-level neighbour node just depends on the distance between it and transform unit node. However, the sub-nodes distribution of each parent-level neighbour node has been known when process current transform unit node. Hence, the weight can be improved according to sub-nodes distribution of parent-level neighbour node.

### 5. DETAILED SOLUTIONS

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) The attribute information of one node A may be derived to predict the attribute information of another node B.
   a. In one example, node A and node B may share the same octree depth.
   b. In one example, node A and node B may have different octree depths.
2) The attribute information of neighbour nodes that have the same octree depth with the current node may be used to predict the attribute information of at least one sub-node of the current node.
   a. In one example, for each sub-node, one neighbour node may be one node that shares at least a face, or an edge, or a vertex with the current sub-node.
   b. In one example, for each sub-node, one neighbour node may be one node that shares at least a face, or an edge, or a vertex with the current node.
   c. In one example, one neighbour node may be one node that is near with the current sub-node or the current node.
   d. In one example, whether to use the prediction from a neighbouring node may be signaled from the encoder to the decoder.
   e. In one example, whether to use the prediction from a neighbouring node may be derived by the decoder.
   f. In one example, to use the prediction from which neighbouring node may be signaled from the encoder to the decoder.
   g. In one example, to use the prediction from which neighbouring node may be derived by the decoder.
3) The attribute information of the neighbour sub-nodes may be used to predict the attribute information of at least one sub-node of the current node.
   a. In one example, the neighbour sub-nodes may be the sub-nodes of neighbour nodes.
      i. In one example, one neighbour node may be one node that shares at least a face, or an edge, or a vertex with the current sub-node.
      ii. In one example, one neighbour node may be one node that shares at least a face, or an edge, or a vertex with the current node.
   b. In one example, the neighbour sub-nodes are processed before the sub-nodes of the current node.
      i. In one example, the processing operation is encoding or decoding operation.
      ii. In one example, the processing operation is transformation or inverse transformation operation.
   c. In one example, the sub-nodes of neighbour node may share at least a face, or an edge, or a vertex with the current sub-node.
   d. In one example, the sub-nodes of neighbour node may share at least a face, or an edge, or a vertex with the current node.
   e. In one example, the attribute information of neighbour sub-nodes may be used to revise the attribute information of their corresponding neighbour node.
      i. In one example, the sub-nodes of neighbour node may share at least a face, or an edge, or a vertex with the current sub-node.
      ii. In one example, the attribute information of neighbour sub-nodes maybe replaces the attribute information of their corresponding neighbour node.
   f. In one example, whether to use the prediction from a neighbouring sub-node may be signaled from the encoder to the decoder.
   g. In one example, whether to use the prediction from a neighbouring sub-node may be derived by the decoder.
   h. In one example, to use the prediction from which neighbouring sub-node may be signaled from the encoder to the decoder.
      i. In one example, to use the prediction from which neighbouring sub-node may be derived by the decoder.
4) The attribute information of preceding sub-nodes may be used to predict the attribute information of the current sub-node.
   a. In one example, the preceding sub-nodes may be the sub-nodes of current node.
   b. In one example, the preceding sub-nodes may be the sub-nodes of any node encoded/decoded before current node.
5) An indicator (e.g., being binary value) may be used to indicate whether the attribute information of nodes that share the same octree depth with the current sub-node is used to predict the attribute information of the current sub-node.
   a. In one example, the indicator may be signaled in the bitstream.
   b. Alternatively, the indicator may be inferred in decoder and/or encoder side.
      i. In one example, the indicator may be inferred according to point cloud density.
   c. In one example, the indicator may be consistent in one coding unit.
      i. In one example, the coding unit may be frame.
      ii. In one example, the coding unit may be tile.
      iii. In one example, the coding unit may be slice.
      iv. In one example, the coding unit may be octree level.
   d. In one example, the indicator may be consistent in one point cloud sequence.
   e. The indicator may be signaled conditionally.
      i. For example, the indicator may be signaled only if proposed prediction is allowed.
      ii. Whether the proposed prediction is allowed may depend on coding information or it may be signaled beforehead.
   f. A first indicator may be signaled to indicate whether the proposed prediction is used, and a second indicator may be signaled to indicate how to apply the proposed prediction, such as which neighbouring sub-node is used to make the prediction.
   g. The indicator may be binarized with fixed-length coding, EG coding, (truncated) unary coding, etc.
   h. The indicator may be coded with at least one context in arithmetic coding.
      i. The indicator may be bypass coded.
6) A neighbouring sub-node may be adjacent or non-adjacent to the current node.
7) Whether to and/or how to apply a method disclosed above may be signaled from encoder to decoder in a bitstream/frame/tile/slice/octree/etc.
8) There may be a prediction weight for each neighbour sub-node.
   a. In one example, the neighbour sub-nodes may be the sub-nodes of neighbour nodes.
      i. In one example, one neighbour node may be one node that shares at least a face, or an edge, or a vertex with the current sub-node.
      ii. In one example, one neighbour node may be one node that shares at least a face, or an edge, or a vertex with the current node.
      iii. In one example, neighbour node and current node may share the same octree depth.
      iv. In one example, neighbour node and current node may have different octree depths.
   b. In one example, prediction weight of neighbour sub-node may be negatively correlated to the distance.
      i. In one example, the distance may be the Euclidean distance, the Manhattan distance, the Chebyshev distance and so on.
      ii. In one example, the distance may be distance between neighbour node and current node.
      iii. In one example, the distance may be distance between neighbour node and current sub-node.
      iv. In one example, the distance may be distance between neighbour sub-node and current node.
      v. In one example, the distance may be distance between neighbour sub-node and current sub-node.
   c. In one example, the sub-nodes of neighbour node may share at least a face, or an edge, or a vertex with the current sub-node.
   d. In one example, the sub-nodes of neighbour node may share at least a face, or an edge, or a vertex with the current node.
   e. In one example, the prediction weight for neighbour sub-node may be greater than neighbour node of its corresponding type.
      i. The type may mean node that shares at least a face, or an edge, or a vertex with the current node or current sub-node.
      ii. In one example, the prediction weight for neighbour sub-node may be n times as large as the neighbour node prediction weight of its corresponding type.
         1. In one example, n is real number which is greater than 1.
   f. The prediction weight of one neighbour node may be revised according to sub-node of neighbour.
      i. In one example, if neighbour sub-node does not exist, the prediction weight of its corresponding neighbour node may be revised.
         1. In one example, neighbour sub-node may be sub-node that shares at least a face, or an edge, or a vertex with the current node.
         2. In one example, neighbour sub-node may be sub-node that shares at least a face, or an edge, or a vertex with the current sub-node.
         3. In one example, the prediction weight can be decreased.
         a. In one example, the prediction weight can be reduced through divided by a number.
         4. In one example, the prediction weight can be increased.
         a. In one example, the prediction weight can be reduced through multiplied by a number.
      ii. In one example, the neighbour sub-nodes are processed before or after the sub-nodes of the current node.
         1. In one example, the processing operation is encoding or decoding operation.
         2. In one example, the processing operation is transformation or inverse transformation operation.
9) The prediction weight of at least one neighbour node may be signaled to the decoder in a bitstream unit.
   a. In one example, the bitstream unit may be the bitstream of the syntax structure of parameter set.
      i. In one example, the syntax structure may be SPS.
      ii. In one example, the syntax structure may be GPS.
      iii. In one example, the syntax structure may be APS.
   b. In one example, the bitstream unit may be the bitstream of one tile.
   c. In one example, the bitstream unit may be the bitstream of one slice.
      i. In one example, the slice may be attribute slice, geometry slice.
   d. In one example, the bitstream unit may be slice header.
      i. In one example, the slice may be attribute slice, geometry slice.
   e. In one example, the prediction weight may be binarized with fixed-length coding, EG coding, (truncated) unary coding, etc.
   f. In one example, the prediction weight may be coded with at least one context in arithmetic coding.
   g. In one example, the prediction weight may be bypass coded.
   h. In one example, the prediction weight may be coded in predictive way.
   i. In one example, the prediction weight may be converted to another form before coding.
      i. In one example, the prediction weight may be subtracted by an integer number, such as 1.
10) The prediction weight of at least one neighbour node may be normalized.
   a. In one example, the normalization may mean that the sum of prediction weights of neighbour nodes is a constant.
      i. In one example, the constant may be 1.
      ii. In one example, neighbour nodes may include all current node's neighbour nodes.
      iii. In one example, neighbour nodes may include current node's neighbour nodes that contain at least one point.
   b. In one example, the weight may be expressed as fraction

$$\frac{x}{y} .$$

i. In one example, only the numerator x may be signaled for one weight.
ii. In one example, the denominator y may be a constant for all weight.
   1. In one example, the denominator y may be signaled only one time for all weight.
   2. In one example, the constant may be 2ⁿ, where n is non-negative integer.
c. In one example, only partial prediction weights may be signaled.
   i. In one example, the rest of prediction weights may be inferred.

### 6. EMBODIMENTS

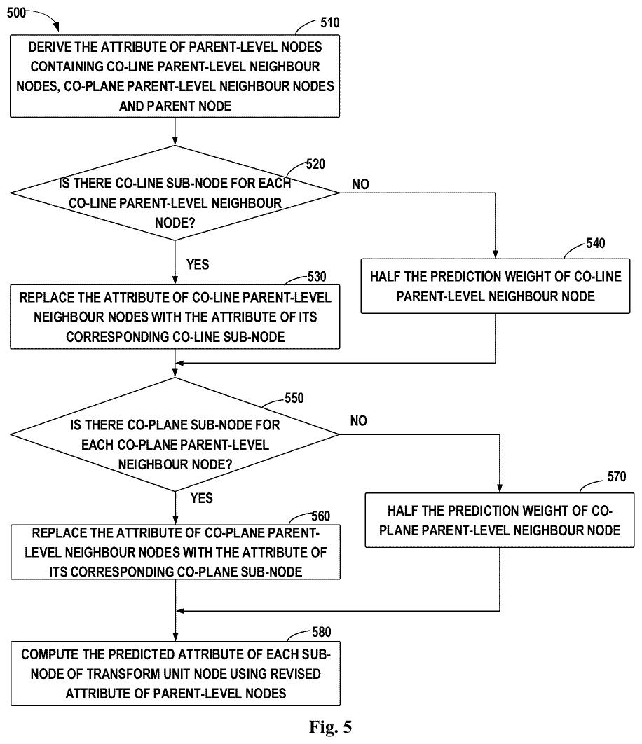

An example of the coding flow 500 for the improvement of point cloud attribute transform domain prediction is depicted in FIG. 5. At block 510, the attribute of parent-level nodes containing co-line parent-level neighbour nodes, co-plane parent-level neighbour nodes and parent node is derived. At block 520, whether co-line sub-node for each co-line parent-level neighbour node exists is determined. If at block 520 it is determined that there is co-line sub-node for each co-line parent-level neighbour node, at block 530, the attribute of co-line parent-level neighbour nodes with the attribute of its corresponding co-line sub-node is replaced. If at block 520 it is determined that there is no co-line sub-node for each co-line parent-level neighbour node, at block 540, the prediction weight of co-line parent-level neighbour node is halved.

At block 550, whether co-plane sub-node for each co-plane parent-level neighbour node exists is determined. If at block 550 it is determined that there is co-plane sub-node for each co-plane parent-level neighbour node, at block 560, the attribute of co-plane parent-level neighbour nodes with the attribute of its corresponding co-plane sub-node is replaced. If at block 550 it is determined that there is no co-plane sub-node for each co-plane parent-level neighbour node, at block 570, the prediction weight of co-plane parent-level neighbour node is halved. At block 580, the predicted attribute of each sub-node of transform unit node is calculated using revised attribute of parent-level nodes.

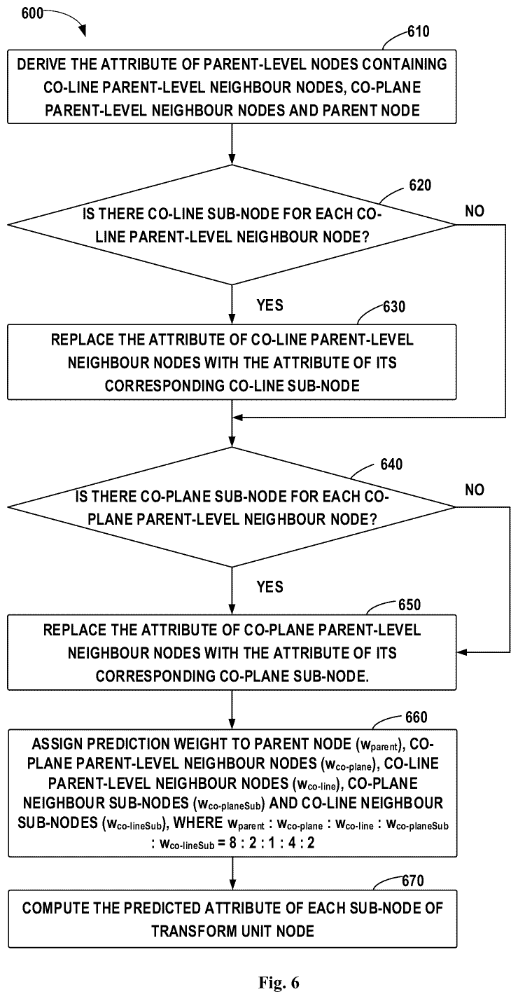

Another example of the coding flow 600 for the improvement of point cloud attribute transform domain prediction is depicted in FIG. 6. At block 610, the attribute of parent-level nodes containing co-line parent-level neighbour nodes, co-plane parent-level neighbour nodes and parent node is derived. At block 620, whether co-line sub-node for each co-line parent-level neighbour node exists is determined. If at block 620 it is determined that there is co-line sub-node for each co-line parent-level neighbour node, at block 630, the attribute of co-line parent-level neighbour nodes with the attribute of its corresponding co-line sub-node is replaced. If at block 620 it is determined that there is no co-line sub-node for each co-line parent-level neighbour node, the coding flow proceeds with block 640.

At block 640, whether co-plane sub-node for each co-plane parent-level neighbour node exists is determined. If at block 640 it is determined that there is co-plane sub-node for each co-plane parent-level neighbour node, at block 650, the attribute of co-plane parent-level neighbour nodes with the attribute of its corresponding co-plane sub-node is replaced. If at block 640 it is determined that there is no co-plane sub-node for each co-plane parent-level neighbour node, the coding flow 600 proceeds with block 660. At block 660, respective prediction weights are assigned to parent node (wₚₐᵣₑₙₜ), co-plane parent-level neighbour nodes (w_{co-plane}), co-line parent-level neighbour nodes (w_{co-line}), co-plane neighbour sub-nodes (w_{co-planeSub}) and/or co-line neighbour sub-nodes (w_{co-lineSub}), where wₚₐᵣₑₙₜ:w_{co-plane}:w_{co-line}:w_{co-planeSub}:w_{co-lineSub}=8:2:1:4:2. At block 670, the predicted attribute of each sub-node of transform unit node is calculated.

The embodiments of the present disclosure are related to motion information coding for point cloud coding. As used herein, the term “point cloud sequence” may refer to a sequence of one or more point clouds. The term “frame” may refer to a point cloud in a point cloud sequence. The term “point cloud” may refer to a frame in the point cloud sequence.

As used herein, the term “node” may represent a spatial partition of a frame. For example, a node 410 in FIG. 4 may be a current node of the current frame. A node may be partitioned or split into a plurality of sub-nodes. As used herein, the term “sub-node” may be a portion or partition of a node. For example, a sub-node 420 is a sub-node of the current node 410. The current node 410 may be referred to as a parent node of the sub-node 420. The current node may have at least one neighbour node, such as the neighbour node 430, or any other node sharing at least one of a face, an edge or a vertex with the current node 410.

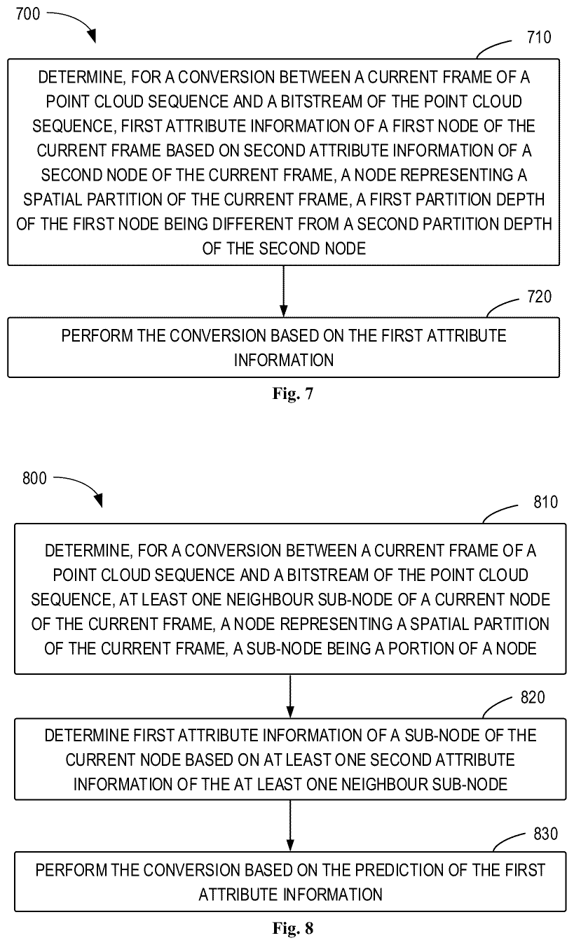

FIG. 7 illustrates a flowchart of a method 700 for point cloud coding in accordance with embodiments of the present disclosure. The method 700 may be implemented for a conversion between a current frame of a point cloud sequence and a bitstream of the point cloud sequence. As shown in FIG. 7, the method 700 starts at block 710, where first attribute information of a first node of the current frame is determined based on second attribute information of a second node of the current frame. A node represents a spatial partition of the current frame. A first partition depth of the first node is different from a second partition depth of the second node.

In some embodiments, the first partition depth may be a first octree depth, and the second partition depth may be a second octree depth. For example, attribute information of a node A may be derived to predict attribute information of another node B, and node A and node B may have different octree depths.

At block 720, the conversion is performed based on the first attribute information. In some embodiments the conversion may include encoding the current frame into the bitstream. Alternatively, or in addition, the conversion may include decoding the current frame from the bitstream.

The method 700 enables predicting attribute information of a node by using attribute information of another node with a different octree depth. In this way, the coding efficiency and coding effectiveness can be improved.

In some embodiments, the first node comprises a sub-node of a current node of the current frame, and the second node comprises a neighbour node of the current node, the second partition depth of the neighbour node being the same with a third partition depth of the current node. That is, the attribute information of neighbour nodes that have the same octree depth with the current node may be used to predict the attribute information of at least one sub-node of the current node.

In some embodiments, the neighbour node shares at least one of the following with the sub-node: a face, an edge or a vertex.

In some embodiments, the neighbour node shares at least one of the following with the current node: a face, an edge or a vertex.

In some embodiments, at least one of a first distance between the neighbour node and the sub-node or a second distance between the neighbour node and the current node is less than or equal to a threshold distance. That is, one neighbour node may be one node that is near with the current sub-node or the current node.

In some embodiments, first information regarding whether to use a prediction of attribute information of the neighbour node during the conversion is included in the bitstream. For example, whether to use the prediction from a neighbouring node may be signaled from the encoder to the decoder.

In some embodiments, the method 700 further comprises: determining first information regarding whether to use a prediction of attribute information of the neighbour node during the conversion. For example, whether to use the prediction from a neighbouring node may be derived by the decoder.

In some embodiments, the current node has a plurality of neighbour nodes, and second information regarding a target neighbour node in the plurality of neighbour nodes is included in the bitstream, a prediction of attribute information of the target neighbour node being used during the conversion.

In some embodiments, the current node has a plurality of neighbour nodes, and the method further comprises: determining second information regarding a target neighbour node in the plurality of neighbour nodes in the bitstream, a prediction of attribute information of the target neighbour node being used during the conversion.

In some embodiments, the method 700 further comprises: determining third attribute information of a third node of the current frame based on the second attribute information, a fourth partition depth of the third node being the same with the second partition depth. That is, attribute information of a node may be derived to predict attribute information of another node, these two nodes may have the same octree-depth.

According to further embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, first attribute information of a first node of a current frame of the point cloud sequence is determined based on second attribute information of a second node of the current frame. A node represents a spatial partition of the current frame. A first partition depth of the first node is different from a second partition depth of the second node. The bitstream is generated based on the first attribute information.

According to still further embodiments of the present disclosure, a method for storing a bitstream of a point cloud sequence is proposed. In the method, first attribute information of a first node of a current frame of the point cloud sequence is determined based on second attribute information of a second node of the current frame. A node represents a spatial partition of the current frame. A first partition depth of the first node is different from a second partition depth of the second node. The bitstream is generated based on the first attribute information. The bitstream is stored in a non-transitory computer-readable recording medium.

FIG. 8 illustrates a flowchart of a method 800 for point cloud coding in accordance with embodiments of the present disclosure. The method 800 may be implemented for a conversion between a current frame of a point cloud sequence and a bitstream of the point cloud sequence. As shown in FIG. 8, the method 800 starts at block 810, where at least one neighbour sub-node of a current node of the current frame is determined. A node represents a spatial partition of the current frame.

At block 820, first attribute information of a sub-node of the current node is determined based on at least one second attribute information of the at least one neighbour sub-node.

At block 830, the conversion is performed based on the first attribute information. In some embodiments the conversion may include encoding the current frame into the bitstream. Alternatively, or in addition, the conversion may include decoding the current frame from the bitstream.

The method 800 enables predicting attribute information of a sub-node of the current node based on attribute information of a neighbour node or a neighbour sub-node, and thus can improve the efficiency of the point cloud coding.

In some embodiments, the at least one neighbour sub-node of the current node comprises a plurality of sub-nodes of a neighbour node of the current node.

In some embodiments, the neighbour node shares at least one of the following with the sub-node of the current node: a face, an edge or a vertex.

In some embodiments, the neighbour node shares at least one of the following with the current node: a face, an edge or a vertex.

In some embodiments, the method 800 further comprises: revising third attribute information of the neighbour node based on the at least one second attribute information of the at least one neighbour sub-node.

In some embodiments, revising the third attribute information of the neighbour node comprises: if a neighbour sub-node of the at least one neighbour sub-node shares at least one of the following with the sub-node of the current node: a face, an edge, or a vertex, revising the third attribute information.

In some embodiments, revising the third attribute information of the neighbour node comprises: replacing the third attribute information with the at least one second attribute information.

In some embodiments, a processing operation is applied to the at least one neighbour sub-node of the current node before being applied to the sub-node of the current node.

In some embodiments, the processing operation comprises one of: an encoding operation, or a decoding operation.

In some embodiments, the processing operation comprises one of: a transformation operation, or an inverse transformation operation.

In some embodiments, the at least one neighbour sub-node of the current node share at least one of the following with the sub-node of the current node: a face, an edge or a vertex.

In some embodiments, the at least one neighbour sub-node of the current node share at least one of the following with the current node: a face, an edge or a vertex.

In some embodiments, first information regarding whether to use a prediction of the at least one attribute information of the at least one neighbour sub-node during the conversion is included in the bitstream. For example, whether to use the prediction from a neighbouring sub-node may be signaled from the encoder to the decoder.

In some embodiments, the method 800 further comprises: determining first information regarding whether to use a prediction of the at least one attribute information of the at least one neighbour sub-node during the conversion. For example, whether to use the prediction from a neighbouring sub-node may be derived by the decoder.

In some embodiments, the at least one neighbour sub-node comprises a plurality of neighbour sub-nodes, and second information regarding a target neighbour sub-node in the plurality of neighbour sub-nodes is included in the bitstream, a prediction of second attribute information of the target neighbour sub-node being used during the conversion. For example, to use the prediction from which neighbouring sub-node may be signaled from the encoder to the decoder.

In some embodiments, the at least one neighbour sub-node comprises a plurality of neighbour sub-nodes, and the method further comprises: second information regarding a target neighbour sub-node in the plurality of neighbour sub-nodes, a prediction of second attribute information of the target neighbour sub-node being used during the conversion. For example, to use the prediction from which neighbouring sub-node may be derived by the decoder.

In some embodiments, a first neighbour sub-node of the at least one neighbour sub-node is adjacent to the current node.

In some embodiments, a second neighbour sub-node of the at least one neighbour sub-node is non-adjacent to the current node.

According to further embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one neighbour sub-node of a current node of a current frame of the point cloud sequence is determined. A node represents a spatial partition of the current frame. A sub-node is a portion of a node. First attribute information of a sub-node of the current node is determined based on at least one second attribute information of the at least one neighbour sub-node. The bitstream is generated based on the first attribute information.

According to still further embodiments of the present disclosure, a method for storing a bitstream of a point cloud sequence is proposed. In the method, at least one neighbour sub-node of a current node of a current frame of the point cloud sequence is determined. A node represents a spatial partition of the current frame. A sub-node is a portion of a node. First attribute information of a sub-node of the current node is determined based on at least one second attribute information of the at least one neighbour sub-node. The bitstream is generated based on the first attribute information. The bitstream is stored in a non-transitory computer-readable recording medium.

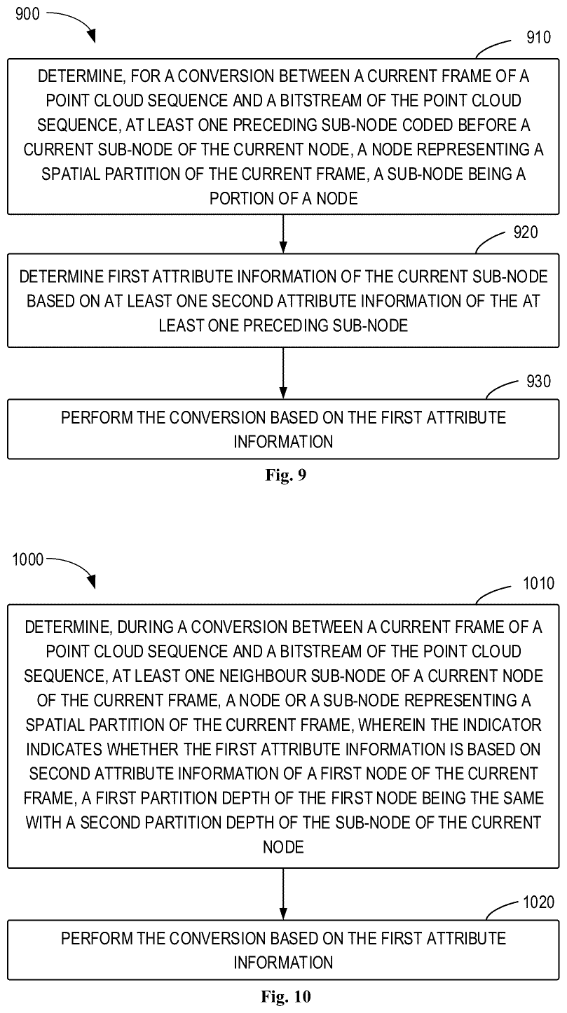

FIG. 9 illustrates a flowchart of a method 900 for point cloud coding in accordance with embodiments of the present disclosure. The method 900 may be implemented for a conversion between a current frame of a point cloud sequence and a bitstream of the point cloud sequence. As shown in FIG. 9, the method 900 starts at block 910, where at least one preceding sub-node coded before a current sub-node of a current node of the current frame is determined. A node represents a spatial partition of the current frame. A sub-node is a portion of a node.

At block 920, first attribute information of the current sub-node is determined based on at least one second attribute information of the at least one preceding sub-node.

At block 930, the conversion is performed based on the attribute information. In some embodiments the conversion may include encoding the current frame into the bitstream. Alternatively, or in addition, the conversion may include decoding the current frame from the bitstream.

The method 900 enables predicting attribute information of a current sub-node based on attribute information of at least one previously coded preceding sub-node, and thus can improve the efficiency of the point cloud coding.

In some embodiments, the at least one preceding sub-node comprises sub-nodes of the current node. In some embodiments, the at least one preceding sub-node comprises sub-nodes of a node coded before the current node.

According to further embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one preceding sub-node coded before a current sub-node of a current node of a current frame of the point cloud sequence is determined. A node represents a spatial partition of the current frame. A sub-node is a portion of a node. First attribute information of the current sub-node is determined based on at least one second attribute information of the at least one preceding sub-node. The bitstream is generated based on the first attribute information.

According to still further embodiments of the present disclosure, a method for storing a bitstream of a point cloud sequence is proposed. In the method, at least one preceding sub-node coded before a current sub-node of a current node of a current frame of the point cloud sequence is determined. A node represents a spatial partition of the current frame. A sub-node is a portion of a node. First attribute information of the current sub-node is determined based on at least one second attribute information of the at least one preceding sub-node. The bitstream is generated based on the first attribute information. The bitstream is stored in a non-transitory computer-readable recording medium.

FIG. 10 illustrates a flowchart of a method 1000 for point cloud coding in accordance with embodiments of the present disclosure. The method 1000 may be implemented for a conversion between a current frame of a point cloud sequence and a bitstream of the point cloud sequence. As shown in FIG. 7, the method 1000 starts at block 1010, where first attribute information of a sub-node of a current node of the current frame is determined based on an indicator. A node represents a spatial partition of the current frame. The indicator indicates whether the first attribute information is based on second attribute information of a first node of the current frame. A first partition depth of the first node is the same with a second partition depth of the sub-node of the current node. For example, a first octree depth of the first node is the same with a second octree depth of the sub-node of the current node. An indicator (e.g., being binary value) may be used to indicate whether the attribute information of nodes that share the same octree depth with the current sub-node is used to predict the attribute information of the current sub-node.

At block 1020, the conversion is performed based on the first attribute information. In some embodiments the conversion may include encoding the current frame into the bitstream. Alternatively, or in addition, the conversion may include decoding the current frame from the bitstream.

The method 1000 enables using an indicator to indicate whether to predict first attribute information of a sub-node based on second attribute information of another sub-node with the same partition depth, and thus can improve the efficiency of the point cloud coding.

In some embodiments, the indicator is included in the bitstream. In some embodiments, if a prediction tool is enabled for the conversion, the indicator is included in the bitstream. For example, if a proposed prediction is allowed, the indicator may be signaled.

In some embodiments, the method 1000 further comprises: determining whether the prediction tool is enabled for the conversion based on coding information. That is, whether the proposed prediction is allowed may depend on coding information.

In some embodiments, a first indicator indicating whether the prediction tool is enabled is included in the bitstream. That is, whether the proposed prediction is allowed may be signaled beforehand.

In some embodiments, a second indicator indicating an applying of the prediction tool is included in the bitstream.

In some embodiments, the second indicator further indicates a neighbour sub-node of the current node to be used for the prediction of the first attribute information.

In some embodiments, the method 1000 further comprises: determining the indicator by at least one of: a decoder side or an encoder side associated with the conversion. That is, the indicator may be inferred in decoder and/or encoder side.

In some embodiments, determining the indicator comprises: determining the indicator based on a point cloud density of the point cloud sequence.

In some embodiments, the indicator is consistent in a coding unit of the point cloud sequence. In some embodiments, the coding unit comprises at least one of: a frame, a tile, a slice, or an octree level.

In some embodiments, the indicator is consistent in the point cloud sequence.

In some embodiments, the indicator is binarized by at least one of the following coding tools: a fixed-length coding tool, an exponential Golomb (EG) coding tool, a unary coding tool, or a truncated unary coding tool.

In some embodiments, the indicator is coded with at least one context in an arithmetic coding. In some embodiments, the indicator is bypass coded.

According to further embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, first attribute information of a sub-node of a current node of a current frame of the point cloud sequence is determined based on an indicator. A node represents a spatial partition of the current frame. A sub-node is a portion of a node. The indicator indicates whether the first attribute information is based on second attribute information of a first node of the current frame. A first partition depth of the first node is the same with a second partition depth of the sub-node of the current node. The bitstream is generated based on the first attribute information.

According to still further embodiments of the present disclosure, a method for storing a bitstream of a point cloud sequence is proposed. In the method, first attribute information of a sub-node of a current node of a current frame of the point cloud sequence is determined based on an indicator. A node represents a spatial partition of the current frame. A sub-node is a portion of a node. The indicator indicates whether the first attribute information is based on second attribute information of a first node of the current frame. A first partition depth of the first node is the same with a second partition depth of the sub-node of the current node. The bitstream is generated based on the first attribute information. The bitstream is stored in a non-transitory computer-readable recording medium.

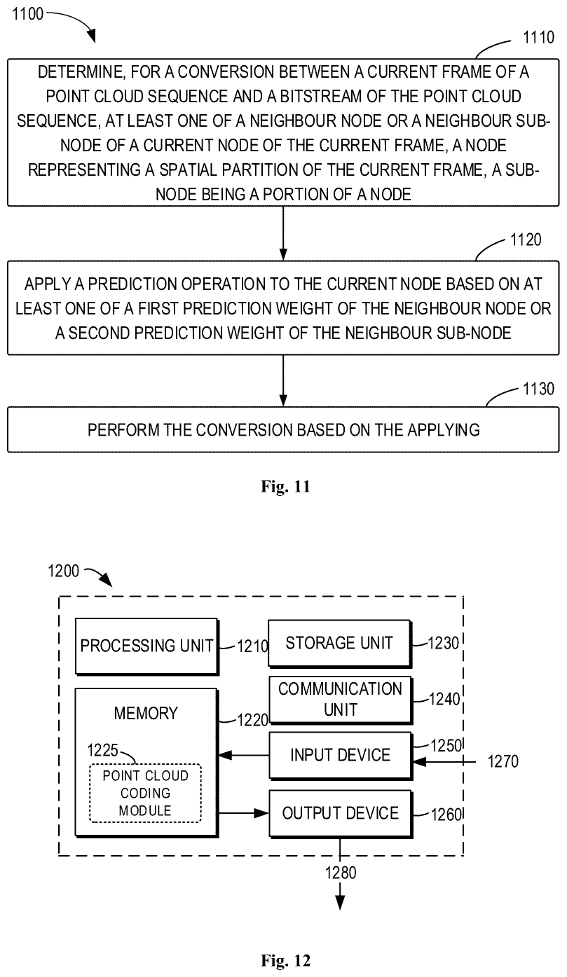

FIG. 11 illustrates a flowchart of a method 1100 for point cloud coding in accordance with embodiments of the present disclosure. The method 1100 may be implemented for a conversion between a current frame of a point cloud sequence and a bitstream of the point cloud sequence. As shown in FIG. 11, the method 1100 starts at block 1110, where a neighbour node or a neighbour sub-node of current node is determined. A node represents a spatial partition of the current frame. A sub-node is a portion of a node.

At block 1120, a prediction operation is applied to the current node based on at least one of a first prediction weight of the neighbour node or a second prediction weight of the neighbour sub-node. For example, the prediction operation may be predicting attribute information of the current node or current sub-node. The prediction weight for the neighbour node or neighbour sub-node may be a prediction weight to be used in the attribute information prediction of the current node or current sub-node. If a plurality of neighbour sub-nodes may be used in the attribute information prediction of the current node, a plurality of prediction weights may be applied to a plurality of attribute information of the neighbour sub-nodes for the attribute information prediction of the current node.

At block 1130, the conversion is performed based on the applying. In some embodiments the conversion may include encoding the current frame into the bitstream. Alternatively, or in addition, the conversion may include decoding the current frame from the bitstream.

The method 1100 enables applying a prediction operation to the current node based on a prediction weight of a neighbour node or a prediction weight of a neighbour sub-node, and thus can improve the efficiency of the point cloud coding.

In some embodiments, the prediction operation comprises at least one of: predicting first attribute information of the current node, or predicting second attribute information of a sub-node of the current node.

In some embodiments, the candidate node is the neighbour sub-node, the neighbour sub-node being a sub-node of the neighbour node of the current node.

In some embodiments, the neighbour node shares at least one of the following with a sub-node of the current node: a face, an edge or a vertex. In some embodiments, the neighbour node shares at least one of the following with the current node: a face, an edge or a vertex.

In some embodiments, a first partition depth of the neighbour node is same with a second partition depth of the current node. In some embodiments, a first partition depth of the neighbour node is different from a second partition depth of the current node.

In some embodiments, the prediction weight of the neighbour sub-node is negative correlated to at least one of: a first distance associated with the neighbour sub-node or a second distance associated with the neighbour node.

In some embodiments, the first distance comprises at least one of: a distance between the neighbour node and the current node, or a distance between the neighbour node and a sub-node of the current node.

In some embodiments, the second distance comprises at least one of: a distance between the neighbour sub-node and the current node, or a distance between the neighbour sub-node and a sub-node of the current node.

In some embodiments, the at least one of the first distance or the second distance comprises one of the following: a Euclidean distance, a Manhattan distance, or a Chebyshev distance.

In some embodiments, a sub-node of the neighbour node shares at least one of the following with a sub-node of the current node: a face, an edge or a vertex. In some embodiments, a sub-node of the neighbour node shares at least one of the following with the current node: a face, an edge or a vertex.

In some embodiments, the prediction weight of the neighbour sub-node is greater than a prediction weight of a further neighbour node, a first sharing type of the neighbour sub-node is the same with a second sharing type of the further neighbour node, a sharing type of a node or a sub-node representing a type of element sharing between a plurality of spatial partitions.

In some embodiments, the sharing type comprises at least one of: a face type that the neighbour node or neighbour sub-node shares a same face with the current node or a sub-node of the current node, an edge type that the neighbour node or neighbour sub-node shares a same edge with the current node or the sub-node of the current node, or a vertex type that the neighbour node or neighbour sub-node shares a same vertex with the current node or the sub-node of the current node. As used herein, a neighbour node sharing an edge with the current node may be referred to as “co-line parent-level neighbour node”. A neighbour node sharing a face with the current node may be referred to as “co-plane parent-level neighbour node”.

In some embodiments, the prediction weight of the neighbour sub-node is a plurality of times of the prediction weight of the further neighbour node, the number of the plurality of times being greater than 1.

In some embodiments, the method 1100 further comprises: revising first prediction weight of the neighbour node based on a prediction weight of a sub-node of the neighbour node.

In some embodiments, if the neighbour node has no sub-node, first prediction weight of the neighbour node is kept without revising.

In some embodiments, a sub-node of the neighbour node shares at least one of the following with a sub-node of the current node: a face, an edge or a vertex. In some embodiments, a sub-node of the neighbour node shares at least one of the following with the current node: a face, an edge or a vertex.

In some embodiments, revising the first prediction weight comprises one of: decreasing the first prediction weight, or increasing the first prediction weight.

In some embodiments, the decreasing or increasing the first prediction weight is based on a predefined factor.

In some embodiments, a processing operation is applied to the neighbour sub-node before being applied to a sub-node of the current node.

In some embodiments, the processing operation comprises one of: an encoding operation, or a decoding operation. In some embodiments, the processing operation comprises one of: a transformation operation, or an inverse transformation operation.

In some embodiments, first prediction weight of the neighbour node is included in a bitstream unit in the bitstream. In some embodiments, the bitstream unit comprises at least one of: a syntax structure of a parameter set, a tile, a slice, or a slice header.

In some embodiments, the syntax structure of the parameter set comprises at least one of: a sequence parameter set (SPS), a geometry parameter set (GPS), or an adaptation parameter set (APS). In some embodiments, the slice comprises at least one of: an attribute slice or a geometry slice.

In some embodiments, the first prediction weight is binarized by at least one of the following coding tool: a fixed-length coding tool, an exponential Golomb (EG) coding tool, a unary coding tool, or a truncated unary coding tool.

In some embodiments, the first prediction weight is coded with at least one context in an arithmetic coding.

In some embodiments, the first prediction weight is bypass coded.

In some embodiments, the first prediction weight is coded in a predictive way.

In some embodiments, the method 1100 further comprises: updating the first prediction weight based on a conversion metric before coding the first prediction weight.

In some embodiments, updating the first prediction weight comprises: subtracting the first prediction weight by a predefined integer value, such as 1.

In some embodiments, the method 1100 further comprises: updating a plurality of prediction weights for a plurality of neighbour nodes of the current node by applying a normalization process.

In some embodiments, a sum of the plurality of updated prediction weights is a predefined value.

In some embodiments, the predefined value is 1.

In some embodiments, the plurality of neighbour nodes comprises at least a part of neighbour nodes of the current node.

In some embodiments, a neighbour node of the plurality of neighbour nodes contains at least one point.

In some embodiments, the plurality of prediction weights is represented as a plurality of fractions. For example, a prediction weight may be expressed as fraction

$$\frac{x}{y} .$$

In some embodiments, a numerator of a fraction in the plurality of fractions is included in the bitstream. In some embodiments, a plurality of denominators of the plurality of fractions is a same value. In some embodiments, the value of the plurality of denominators is included in the bitstream for a single time.

In some embodiments, the value is two to the power of a non-negative integer, such as 2ⁿ, where n is non-negative integer.

In some embodiments, a part of the plurality of prediction weights is included in the bitstream. In some embodiments, a remaining part of the plurality of prediction weights is determined during the conversion.

According to further embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, at least one of a neighbour node or a neighbour sub-node of a current node of a current frame of the point cloud sequence is determined. A node represents a spatial partition of the current frame. A sub-node is a portion of a node. A prediction operation is applied to the current node based on at least one of a first prediction weight of the neighbour node or a second prediction weight of the neighbour sub-node. The bitstream is generated based on the applying.

According to still further embodiments of the present disclosure, a method for storing a bitstream of a point cloud sequence is proposed. In the method, at least one of a neighbour node or a neighbour sub-node of a current node of a current frame of the point cloud sequence is determined. A node represents a spatial partition of the current frame. A sub-node is a portion of a node. A prediction operation is applied to the current node based on at least one of a first prediction weight of the neighbour node or a second prediction weight of the neighbour sub-node. The bitstream is generated based on the applying. The bitstream is stored in a non-transitory computer-readable recording medium.

In some example embodiments, information indicating an applying of the methods 700, 800, 900, 1000 and/or 1100 may be included in the bitstream. For example, the information may indicate whether to and/or how to apply the methods 700, 800, 900, 1000 and/or 1100. By way of example, the information may be included from an encoder to a decoder in one of the following: the bitstream, a frame, a tile, a slice, or an octree.

By using these the methods 700, 800, 900, 1000 and/or 1100 separately or in combination, the coding effectiveness and coding efficiency of the point cloud coding can be improved.

Implementations of the present disclosure can be described in view of the following clauses, the features of which can be combined in any reasonable manner.

Clause 1. A method for point cloud coding, comprising: determining, for a conversion between a current frame of a point cloud sequence and a bitstream of the point cloud sequence, first attribute information of a first node of the current frame based on second attribute information of a second node of the current frame, a node representing a spatial partition of the current frame, a first partition depth of the first node being different from a second partition depth of the second node; and performing the conversion based on the first attribute information.

Clause 2. The method of clause 1, wherein the first partition depth comprises a first octree depth, and the second partition depth comprises a second octree depth.

Clause 3. The method of clause 1 or clause 2, wherein the first node comprises a sub-node of a current node of the current frame, and the second node comprises a neighbour node of the current node, the second partition depth of the neighbour node being the same with a third partition depth of the current node.

Clause 4. The method of clause 3, wherein the neighbour node shares at least one of the following with the sub-node: a face, an edge or a vertex.

Clause 5. The method of clause 3, wherein the neighbour node shares at least one of the following with the current node: a face, an edge or a vertex.

Clause 6. The method of any of clauses 3-5, wherein at least one of a first distance between the neighbour node and the sub-node or a second distance between the neighbour node and the current node is less than or equal to a threshold distance.

Clause 7. The method of any of clauses 3-6, wherein first information regarding whether to use a prediction of attribute information of the neighbour node during the conversion is included in the bitstream.

Clause 8. The method of any of clauses 3-6, further comprising: determining first information regarding whether to use a prediction of attribute information of the neighbour node during the conversion.

Clause 9. The method of any of clauses 3-8, wherein the current node has a plurality of neighbour nodes, and second information regarding a target neighbour node in the plurality of neighbour nodes is included in the bitstream, a prediction of attribute information of the target neighbour node being used during the conversion.

Clause 10. The method of any of clauses 3-8, wherein the current node has a plurality of neighbour nodes, and the method further comprises: determining second information regarding a target neighbour node in the plurality of neighbour nodes in the bitstream, a prediction of attribute information of the target neighbour node being used during the conversion.

Clause 11. The method of clause 1 or clause 2, further comprising: determining third attribute information of a third node of the current frame based on the second attribute information, a fourth partition depth of the third node being the same with the second partition depth.

Clause 12. A method for point cloud coding, comprising: determining, for a conversion between a current frame of a point cloud sequence and a bitstream of the point cloud sequence, at least one neighbour sub-node of a current node of the current frame, a node representing a spatial partition of the current frame; determining first attribute information of a sub-node of the current node based on at least one second attribute information of the at least one neighbour sub-node; and performing the conversion based on the first attribute information.

Clause 13. The method of clause 12, wherein the at least one neighbour sub-node of the current node comprises a plurality of sub-nodes of a neighbour node of the current node.

Clause 14. The method of clause 13, wherein the neighbour node shares at least one of the following with the sub-node of the current node: a face, an edge or a vertex.

Clause 15. The method of clause 13, wherein the neighbour node shares at least one of the following with the current node: a face, an edge or a vertex.

Clause 16. The method of any of clauses 13-15, further comprising: revising third attribute information of the neighbour node based on the at least one second attribute information of the at least one neighbour sub-node.

Clause 17. The method of clause 16, wherein revising the third attribute information of the neighbour node comprises: if a neighbour sub-node of the at least one neighbour sub-node shares at least one of the following with the sub-node of the current node: a face, an edge, or a vertex, revising the third attribute information.

Clause 18. The method of clause 16 or clause 17, wherein revising the third attribute information of the neighbour node comprises: replacing the third attribute information with the at least one second attribute information.

Clause 19. The method of any of clauses 12-18, wherein a processing operation is applied to the at least one neighbour sub-node of the current node before being applied to the sub-node of the current node.

Clause 20. The method of clause 19, wherein the processing operation comprises one of: an encoding operation, or a decoding operation.

Clause 21. The method of clause 19 or clause 20, wherein the processing operation comprises one of: a transformation operation, or an inverse transformation operation.

Clause 22. The method of any of clauses 12-21, wherein the at least one neighbour sub-node of the current node share at least one of the following with the sub-node of the current node: a face, an edge or a vertex.

Clause 23. The method of any of clauses 12-21, wherein the at least one neighbour sub-node of the current node share at least one of the following with the current node: a face, an edge or a vertex.

Clause 24. The method of any of clauses 12-23, wherein first information regarding whether to use a prediction of the at least one attribute information of the at least one neighbour sub-node during the conversion is included in the bitstream.

Clause 25. The method of any of clauses 12-23, further comprising: determining first information regarding whether to use a prediction of the at least one attribute information of the at least one neighbour sub-node during the conversion.

Clause 26. The method of any of clauses 12-25, wherein the at least one neighbour sub-node comprises a plurality of neighbour sub-nodes, and second information regarding a target neighbour sub-node in the plurality of neighbour sub-nodes is included in the bitstream, a prediction of second attribute information of the target neighbour sub-node being used during the conversion.

Clause 27. The method of any of clauses 12-25, wherein the at least one neighbour sub-node comprises a plurality of neighbour sub-nodes, and the method further comprises: second information regarding a target neighbour sub-node in the plurality of neighbour sub-nodes, a prediction of second attribute information of the target neighbour sub-node being used during the conversion.

Clause 28. The method of any of clauses 12-27, wherein a first neighbour sub-node of the at least one neighbour sub-node is adjacent to the current node.

Clause 29. The method of any of clauses 12-27, wherein a second neighbour sub-node of the at least one neighbour sub-node is non-adjacent to the current node.

Clause 30. A method for point cloud coding, comprising: determining, for a conversion between a current frame of a point cloud sequence and a bitstream of the point cloud sequence, at least one preceding sub-node coded before a current sub-node of a current node of the current frame, a node representing a spatial partition of the current frame; determining first attribute information of the current sub-node based on at least one second attribute information of the at least one preceding sub-node; and performing the conversion based on the attribute information.

Clause 31. The method of clause 30, wherein the at least one preceding sub-node comprises sub-nodes of the current node.

Clause 32. The method of clause 30 or clause 31, wherein the at least one preceding sub-node comprises sub-nodes of a node coded before the current node.

Clause 33. A method for point cloud coding, comprising: determining, for a conversion between a current frame of a point cloud sequence and a bitstream of the point cloud sequence, based on an indicator, first attribute information of a sub-node of a current node of the current frame, a node representing a spatial partition of the current frame, wherein the indicator indicates whether the first attribute information is based on second attribute information of a first node of the current frame, a first partition depth of the first node being the same with a second partition depth of the sub-node of the current node; and performing the conversion based on the first attribute information.

Clause 34. The method of clause 33, wherein the indicator is included in the bitstream.

Clause 35. The method of clause 34, wherein if a prediction tool is enabled for the conversion, the indicator is included in the bitstream.

Clause 36. The method of clause 35, further comprising: determining whether the prediction tool is enabled for the conversion based on coding information.

Clause 37. The method of clause 35, wherein a first indicator indicating whether the prediction tool is enabled is included in the bitstream.

Clause 38. The method of any of clauses 35-37, wherein a second indicator indicating an applying of the prediction tool is included in the bitstream.

Clause 39. The method of clause 38, wherein the second indicator further indicates a neighbour sub-node of the current node to be used for the prediction of the first attribute information.

Clause 40. The method of clause 33, further comprising: determining the indicator by at least one of: a decoder side or an encoder side associated with the conversion.

Clause 41. The method of clause 40, wherein determining the indicator comprises: determining the indicator based on a point cloud density of the point cloud sequence.

Clause 42. The method of any of clauses 33-41, wherein the indicator is consistent in a coding unit of the point cloud sequence.

Clause 43. The method of clause 42, wherein the coding unit comprises at least one of: a frame, a tile, a slice, or an octree level.

Clause 44. The method of any of clauses 33-43, wherein the indicator is consistent in the point cloud sequence.

Clause 45. The method of any of clauses 33-44, wherein the indicator is binarized by at least one of the following coding tool: a fixed-length coding tool, an exponential Golomb (EG) coding tool, a unary coding tool, or a truncated unary coding tool.

Clause 46. The method of any of clauses 33-45, wherein the indicator is coded with at least one context in an arithmetic coding.

Clause 47. The method of any of clauses 33-46, wherein the indicator is bypass coded.

Clause 48. A method for point cloud coding, comprising: determining, for a conversion between a current frame of a point cloud sequence and a bitstream of the point cloud sequence, at least one of a neighbour node or a neighbour sub-node of a current node of the current frame, a node representing a spatial partition of the current frame, a sub-node being a portion of a node; applying a prediction operation to the current node based on at least one of a first prediction weight of the neighbour node or a second prediction weight of the neighbour sub-node; and performing the conversion based on the applying.

Clause 49. The method of clause 48, wherein the prediction operation comprises at least one of: predicting first attribute information of the current node, or predicting second attribute information of a sub-node of the current node.

Clause 50. The method of clause 48 or clause 49, wherein the candidate node is the neighbour sub-node, the neighbour sub-node being a sub-node of the neighbour node of the current node.

Clause 51. The method of clause 50, wherein the neighbour node shares at least one of the following with a sub-node of the current node: a face, an edge or a vertex.

Clause 52. The method of clause 50, wherein the neighbour node shares at least one of the following with the current node: a face, an edge or a vertex.

Clause 53. The method of any of clauses 50-52, wherein a first partition depth of the neighbour node is same with a second partition depth of the current node.

Clause 54. The method of any of clauses 50-52, wherein a first partition depth of the neighbour node is different from a second partition depth of the current node.

Clause 55. The method of any of clauses 50-54, wherein the prediction weight of the neighbour sub-node is negative correlated to at least one of: a first distance associated with the neighbour sub-node or a second distance associated with the neighbour node.

Clause 56. The method of clause 55, wherein the first distance comprises at least one of: a distance between the neighbour node and the current node, or a distance between the neighbour node and a sub-node of the current node.

Clause 57. The method of clause 55 or clause 56, wherein the second distance comprises at least one of: a distance between the neighbour sub-node and the current node, or a distance between the neighbour sub-node and a sub-node of the current node.

Clause 58. The method of any of clauses 55-57, wherein the at least one of the first distance or the second distance comprises one of the following: a Euclidean distance, a Manhattan distance, or a Chebyshev distance.

Clause 59. The method of any of clauses 50-58, wherein a sub-node of the neighbour node shares at least one of the following with a sub-node of the current node: a face, an edge or a vertex.

Clause 60. The method of any of clauses 50-59, wherein a sub-node of the neighbour node shares at least one of the following with the current node: a face, an edge or a vertex.

Clause 61. The method of any of clauses 50-60, wherein the prediction weight of the neighbour sub-node is greater than a prediction weight of a further neighbour node, a first sharing type of the neighbour sub-node is the same with a second sharing type of the further neighbour node, a sharing type of a node or a sub-node representing a type of element sharing between a plurality of spatial partitions.

Clause 62. The method of clause 61, wherein the sharing type comprises at least one of: a face type that the neighbour node or neighbour sub-node shares a same face with the current node or a sub-node of the current node, an edge type that the neighbour node or neighbour sub-node shares a same edge with the current node or the sub-node of the current node, or a vertex type that the neighbour node or neighbour sub-node shares a same vertex with the current node or the sub-node of the current node.

Clause 63. The method of clause 61 or clause 62, wherein the prediction weight of the neighbour sub-node is a plurality of times of the prediction weight of the further neighbour node, the number of the plurality of times being greater than 1.

Clause 64. The method of any of clauses 48-63, further comprising: revising first prediction weight of the neighbour node based on a prediction weight of a sub-node of the neighbour node.

Clause 65. The method of any of clauses 48-64, wherein if the neighbour node has no sub-node, first prediction weight of the neighbour node is kept without revising.

Clause 66. The method of clause 64 or clause 65, wherein a sub-node of the neighbour node shares at least one of the following with a sub-node of the current node: a face, an edge or a vertex.

Clause 67. The method of any of clauses 64-66, wherein a sub-node of the neighbour node shares at least one of the following with the current node: a face, an edge or a vertex.

Clause 68. The method of any of clauses 64-67, wherein revising the first prediction weight comprises one of: decreasing the first prediction weight, or increasing the first prediction weight.

Clause 69. The method of clause 68, wherein the decreasing or increasing the first prediction weight is based on a predefined factor.

Clause 70. The method of any of clauses 48-69, wherein a processing operation is applied to the neighbour sub-node before being applied to a sub-node of the current node.

Clause 71. The method of clause 70, wherein the processing operation comprises one of: an encoding operation, or a decoding operation.

Clause 72. The method of clause 70 or clause 71, wherein the processing operation comprises one of: a transformation operation, or an inverse transformation operation.

Clause 73. The method of any of clauses 48-72, wherein first prediction weight of the neighbour node is included in a bitstream unit in the bitstream.

Clause 74. The method of clause 73, wherein the bitstream unit comprises at least one of: a syntax structure of a parameter set, a tile, a slice, or a slice header.

Clause 75. The method of clause 74, wherein the syntax structure of the parameter set comprises at least one of: a sequence parameter set (SPS), a geometry parameter set (GPS), or an adaptation parameter set (APS).

Clause 76. The method of clause 74 or clause 75, wherein the slice comprises at least one of: an attribute slice or a geometry slice.

Clause 77. The method of any of clauses 73-77, wherein the first prediction weight is binarized by at least one of the following coding tool: a fixed-length coding tool, an exponential Golomb (EG) coding tool, a unary coding tool, or a truncated unary coding tool.

Clause 78. The method of any of clauses 73-77, wherein the first prediction weight is coded with at least one context in an arithmetic coding.

Clause 79. The method of any of clauses 73-78, wherein the first prediction weight is bypass coded.

Clause 80. The method of any of clauses 73-79, wherein the first prediction weight is coded in a predictive way.

Clause 81. The method of any of clauses 73-78, further comprising: updating the first prediction weight based on a conversion metric before coding the first prediction weight.

Clause 82. The method of clause 81, wherein updating the first prediction weight comprises: subtracting the first prediction weight by a predefined integer value.

Clause 83. The method of any of clauses 48-82, further comprising: updating a plurality of prediction weights for a plurality of neighbour nodes of the current node by applying a normalization process.

Clause 84. The method of clause 83, wherein a sum of the plurality of updated prediction weights is a predefined value.

Clause 85. The method of clause 84, wherein the predefined value is 1.

Clause 86. The method of any of clauses 83-85, wherein the plurality of neighbour nodes comprises at least a part of neighbour nodes of the current node.

Clause 87. The method of any of clauses 83-86, wherein a neighbour node of the plurality of neighbour nodes contains at least one point.

Clause 88. The method of any of clauses 83-87, wherein the plurality of prediction weights is represented as a plurality of fractions.

Clause 89. The method of clause 88, wherein a numerator of a fraction in the plurality of fractions is included in the bitstream.

Clause 90. The method of clause 88 or clause 89, wherein a plurality of denominators of the plurality of fractions is a same value.

Clause 91. The method of clause 90, wherein the value of the plurality of denominators is included in the bitstream for a single time.

Clause 92. The method of clause 90 or clause 91, wherein the value is two to the power of a non-negative integer.

Clause 93. The method of any of clauses 83-92, wherein a part of the plurality of prediction weights is included in the bitstream.

Clause 94. The method of clause 93, wherein a remaining part of the plurality of prediction weights is determined during the conversion.

Clause 95. The method of any of clauses 1-94, wherein information regarding an applying of the method is included in the bitstream.

Clause 96. The method of clause 95, wherein the information is included in at least one of the following: the bitstream, a frame, a tile, a slice, or an octree.

Clause 97. The method of any of clauses 1-96, wherein the conversion includes encoding the current frame into the bitstream.

Clause 98. The method of any of clauses 1-96, wherein the conversion includes decoding the current frame from the bitstream.

Clause 99. An apparatus for point cloud coding comprising a processor and a non-transitory memory with instructions thereon, wherein the instructions upon execution by the processor, cause the processor to perform a method in accordance with any of clauses 1-98.

Clause 100. A non-transitory computer-readable storage medium storing instructions that cause a processor to perform a method in accordance with any of clauses 1-98.

Clause 101. A non-transitory computer-readable recording medium storing a bitstream of a point cloud sequence which is generated by a method performed by an apparatus for point cloud coding, wherein the method comprises: determining first attribute information of a first node of a current frame of the point cloud sequence based on second attribute information of a second node of the current frame, a node representing a spatial partition of the current frame, a first partition depth of the first node being different from a second partition depth of the second node; and generating the bitstream based on the first attribute information.

Clause 102. A method for storing a bitstream of a point cloud sequence, comprising: determining first attribute information of a first node of a current frame of the point cloud sequence based on second attribute information of a second node of the current frame, a node representing a spatial partition of the current frame, a first partition depth of the first node being different from a second partition depth of the second node; generating the bitstream based on the first attribute information; and storing the bitstream in a non-transitory computer-readable recording medium.

Clause 103. A non-transitory computer-readable recording medium storing a bitstream of a point cloud sequence which is generated by a method performed by an apparatus for point cloud coding, wherein the method comprises: determining at least one neighbour sub-node of a current node of a current frame of the point cloud sequence, a node representing a spatial partition of the current frame, a sub-node being a portion of a node; determining first attribute information of a sub-node of the current node based on at least one second attribute information of the at least one neighbour sub-node; and generating the bitstream based on the first attribute information.

Clause 104. A method for storing a bitstream of a point cloud sequence, comprising: determining at least one neighbour sub-node of a current node of a current frame of the point cloud sequence, a node representing a spatial partition of the current frame, a sub-node being a portion of a node; determining first attribute information of a sub-node of the current node based on at least one second attribute information of the at least one neighbour sub-node; generating the bitstream based on the first attribute information; and storing the bitstream in a non-transitory computer-readable recording medium.

Clause 105. A non-transitory computer-readable recording medium storing a bitstream of a point cloud sequence which is generated by a method performed by an apparatus for point cloud coding, wherein the method comprises: determining at least one preceding sub-node coded before a current sub-node of a current node of a current frame of the point cloud sequence, a node representing a spatial partition of the current frame, a sub-node being a portion of a node; determining first attribute information of the current sub-node based on at least one second attribute information of the at least one preceding sub-node; and generating the bitstream based on the first attribute information.

Clause 106. A method for storing a bitstream of a point cloud sequence, comprising: determining at least one preceding sub-node coded before a current sub-node of a current node of a current frame of the point cloud sequence, a node representing a spatial partition of the current frame, a sub-node being a portion of a node; determining first attribute information of the current sub-node based on at least one second attribute information of the at least one preceding sub-node; and generating the bitstream based on the first attribute information.

Clause 107. A non-transitory computer-readable recording medium storing a bitstream of a point cloud sequence which is generated by a method performed by an apparatus for point cloud coding, wherein the method comprises: determining, based on an indicator, first attribute information of a sub-node of a current node of a current frame of the point cloud sequence, a node representing a spatial partition of the current frame, a sub-node being a portion of a node, wherein the indicator indicates whether the first attribute information is based on second attribute information of a first node of the current frame, a first partition depth of the first node being the same with a second partition depth of the sub-node of the current node; and generating the bitstream based on the first attribute information.

Clause 108. A method for storing a bitstream of a point cloud sequence, comprising: determining, based on an indicator, first attribute information of a sub-node of a current node of a current frame of the point cloud sequence, a node representing a spatial partition of the current frame, a sub-node being a portion of a node, wherein the indicator indicates whether the first attribute information is based on second attribute information of a first node of the current frame, a first partition depth of the first node being the same with a second partition depth of the sub-node of the current node; generating the bitstream based on the first attribute information; and storing the bitstream in a non-transitory computer-readable recording medium.

Clause 109. A non-transitory computer-readable recording medium storing a bitstream of a point cloud sequence which is generated by a method performed by an apparatus for point cloud coding, wherein the method comprises: determining at least one of a neighbour node or a neighbour sub-node of a current node of a current frame of the point cloud sequence, a node representing a spatial partition of the current frame, a sub-node being a portion of a node; applying a prediction operation to the current node based on at least one of a first prediction weight of the neighbour node or a second prediction weight of the neighbour sub-node; and generating the bitstream based on the applying.

Clause 110. A method for storing a bitstream of a point cloud sequence, comprising: determining at least one of a neighbour node or a neighbour sub-node of a current node of a current frame of the point cloud sequence, a node representing a spatial partition of the current frame, a sub-node being a portion of a node; applying a prediction operation to the current node based on at least one of a first prediction weight of the neighbour node or a second prediction weight of the neighbour sub-node; generating the bitstream based on the applying; and storing the bitstream in a non-transitory computer-readable recording medium.

### Example Device

FIG. 12 illustrates a block diagram of a computing device 1200 in which various embodiments of the present disclosure can be implemented. The computing device 1200 may be implemented as or included in the source device 110 (or the GPCC encoder 116 or 200) or the destination device 120 (or the GPCC decoder 126 or 300).

It would be appreciated that the computing device 1200 shown in FIG. 12 is merely for purpose of illustration, without suggesting any limitation to the functions and scopes of the embodiments of the present disclosure in any manner.

As shown in FIG. 12, the computing device 1200 includes a general-purpose computing device 1200. The computing device 1200 may at least comprise one or more processors or processing units 1210, a memory 1220, a storage unit 1230, one or more communication units 1240, one or more input devices 1250, and one or more output devices 1260.

In some embodiments, the computing device 1200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1200 can support any type of interface to a user (such as “wearable” circuitry and the like).

The processing unit 1210 may be a physical or virtual processor and can implement various processes based on programs stored in the memory 1220. In a multi-processor system, multiple processing units execute computer executable instructions in parallel so as to improve the parallel processing capability of the computing device 1200. The processing unit 1210 may also be referred to as a central processing unit (CPU), a microprocessor, a controller or a microcontroller.

The computing device 1200 typically includes various computer storage medium. Such medium can be any medium accessible by the computing device 1200, including, but not limited to, volatile and non-volatile medium, or detachable and non-detachable medium. The memory 1220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1230 may be any detachable or non-detachable medium and may include a machine-readable medium such as a memory, flash memory drive, magnetic disk or another other media, which can be used for storing information and/or data and can be accessed in the computing device 1200.

The computing device 1200 may further include additional detachable/non-detachable, volatile/non-volatile memory medium. Although not shown in FIG. 12, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1240 communicates with a further computing device via the communication medium. In addition, the functions of the components in the computing device 1200 can be implemented by a single computing cluster or multiple computing machines that can communicate via communication connections. Therefore, the computing device 1200 can operate in a networked environment using a logical connection with one or more other servers, networked personal computers (PCs) or further general network nodes.

The input device 1250 may be one or more of a variety of input devices, such as a mouse, keyboard, tracking ball, voice-input device, and the like. The output device 1260 may be one or more of a variety of output devices, such as a display, loudspeaker, printer, and the like. By means of the communication unit 1240, the computing device 1200 can further communicate with one or more external devices (not shown) such as the storage devices and display device, with one or more devices enabling the user to interact with the computing device 1200, or any devices (such as a network card, a modem and the like) enabling the computing device 1200 to communicate with one or more other computing devices, if required. Such communication can be performed via input/output (I/O) interfaces (not shown).

In some embodiments, instead of being integrated in a single device, some or all components of the computing device 1200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1200 may be used to implement point cloud encoding/decoding in embodiments of the present disclosure. The memory 1220 may include one or more point cloud coding modules 1225 having one or more program instructions. These modules are accessible and executable by the processing unit 1210 to perform the functionalities of the various embodiments described herein.

In the example embodiments of performing point cloud encoding, the input device 1250 may receive point cloud data as an input 1270 to be encoded. The point cloud data may be processed, for example, by the point cloud coding module 1225, to generate an encoded bitstream. The encoded bitstream may be provided via the output device 1260 as an output 12120.

In the example embodiments of performing point cloud decoding, the input device 1250 may receive an encoded bitstream as the input 1270. The encoded bitstream may be processed, for example, by the point cloud coding module 1225, to generate decoded point cloud data. The decoded point cloud data may be provided via the output device 1260 as the output 1280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, for a conversion between a current frame of a point cloud sequence and a bitstream of the point cloud sequence, at least one neighbour sub-node of a current node of the current frame, a node representing a spatial partition of the current frame, a sub-node being a portion of a node;
determining first attribute information of a sub-node of the current node based on at least one second attribute information of the at least one neighbour sub-node; and
performing the conversion based on the first attribute information.

2. The method of claim 1, wherein the at least one neighbour sub-node of the current node comprises a plurality of sub-nodes of a neighbour node of the current node.

3. The method of claim 2, wherein the neighbour node shares at least one of the following with the sub-node of the current node: a face, an edge or a vertex, and/or
wherein the neighbour node shares at least one of the following with the current node: a face, an edge or a vertex.

4. The method of claim 2, further comprising:
revising third attribute information of the neighbour node based on the at least one second attribute information of the at least one neighbour sub-node.

5. The method of claim 4, wherein revising the third attribute information of the neighbour node comprises:
if a neighbour sub-node of the at least one neighbour sub-node shares at least one of the following with the sub-node of the current node: a face, an edge, or a vertex, revising the third attribute information.

6. The method of claim 4, wherein revising the third attribute information of the neighbour node comprises:
replacing the third attribute information with the at least one second attribute information.

7. The method of claim 1, wherein a processing operation is applied to the at least one neighbour sub-node of the current node before being applied to the sub-node of the current node.

8. The method of claim 7, wherein the processing operation comprises one of:
an encoding operation, or
a decoding operation.

9. The method of claim 7, wherein the processing operation comprises one of:
a transformation operation, or
an inverse transformation operation.

10. The method of claim 1, wherein the at least one neighbour sub-node of the current node share at least one of the following with the sub-node of the current node: a face, an edge or a vertex, and/or
wherein the at least one neighbour sub-node of the current node share at least one of the following with the current node: a face, an edge or a vertex.

11. The method of claim 1, wherein first information regarding whether to use a prediction of the at least one attribute information of the at least one neighbour sub-node during the conversion is included in the bitstream.

12. The method of claim 1, further comprising:
determining first information regarding whether to use a prediction of the at least one attribute information of the at least one neighbour sub-node during the conversion.

13. The method of claim 1, wherein the at least one neighbour sub-node comprises a plurality of neighbour sub-nodes, and
second information regarding a target neighbour sub-node in the plurality of neighbour sub-nodes is included in the bitstream, a prediction of second attribute information of the target neighbour sub-node being used during the conversion.

14. The method of claim 1, wherein the at least one neighbour sub-node comprises a plurality of neighbour sub-nodes, and
the method further comprises: determining second information regarding a target neighbour sub-node in the plurality of neighbour sub-nodes, a prediction of second attribute information of the target neighbour sub-node being used during the conversion.

15. The method of claim 1, wherein a first neighbour sub-node of the at least one neighbour sub-node is adjacent to the current node.

16. The method of claim 1, wherein a second neighbour sub-node of the at least one neighbour sub-node is non-adjacent to the current node.

17. The method of claim 1, wherein the conversion includes encoding the current frame into the bitstream, and/or
wherein the conversion includes decoding the current frame from the bitstream.

18. An apparatus for processing point cloud data comprising a processor and a non-transitory memory with instructions thereon, wherein the instructions upon execution by the processor, cause the processor to:
determine, for a conversion between a current frame of a point cloud sequence and a bitstream of the point cloud sequence, at least one neighbour sub-node of a current node of the current frame, a node representing a spatial partition of the current frame, a sub-node being a portion of a node;
determine first attribute information of a sub-node of the current node based on at least one second attribute information of the at least one neighbour sub-node; and
perform the conversion based on the first attribute information.

19. A non-transitory computer-readable storage medium storing instructions that cause a processor to:
determine, for a conversion between a current frame of a point cloud sequence and a bitstream of the point cloud sequence, at least one neighbour sub-node of a current node of the current frame, a node representing a spatial partition of the current frame, a sub-node being a portion of a node;
determine first attribute information of a sub-node of the current node based on at least one second attribute information of the at least one neighbour sub-node; and
perform the conversion based on the first attribute information.

20. A non-transitory computer-readable recording medium storing a bitstream of a point cloud sequence which is generated by a method performed by a point cloud processing apparatus, wherein the method comprises:
determining at least one neighbour sub-node of a current node of a current frame of the point cloud sequence, a node representing a spatial partition of the current frame, a sub-node being a portion of a node;
determining first attribute information of a sub-node of the current node based on at least one second attribute information of the at least one neighbour sub-node; and
generating the bitstream based on the first attribute information.
